(19) United States
(12) Patent Application Publication
(10) Pub. No.: US 2010/0005389 A1
(43) Pub. Date: Jan. 7, 2010

(54) Apparatus and method for a user to select one or more pieces of information

(76) Inventors: Soren Borup Jensen, Struer (DK); Henning Nielsen, Struer (DK)

Correspondence Address: HARNESS, DICKEY & PIERCE, P.L.C., P.O.BOX 8910, RESTON, VA, 20195, US

(21) Appl. No.: 12/311,656

(22) PCT Filed: Aug. 15, 2007
(86) PCT No.: PCT/EP2007/058464

§ 371 Date: Apr. 8, 2009

(30) Foreign Application Priority Data
Oct. 27, 2006 (DK) PA 2006 01391

(51) Int. Cl. G06F 3/048; G06F 3/041

(52) U.S. Cl. 715/702; 715/822; 715/812

(57) ABSTRACT

An apparatus and method for a user to select pieces of information. The apparatus comprising a rotatable part or a touch pad for the user to operate to scroll between the pieces of information using a movement along a closed path. Touch or engagement at predetermined position(s) along the closed path will allow the user to select predetermined pieces of information independently of the position of the scrolling.

The present invention relates to improvements in particular in portable handheld apparatus having a mixture of different means for detecting user given control commands, in apparatus like mobile-/cell phones, PDA's, media players (music, video and images), portable PC's, game controllers, GPS equipment and the like.

Existing consumer electronic devices have a user interface that basically includes command keys of different type, e.g. push buttons, dials, key pads, touch pads, and a display, e.g. an LCD screen. Such products may e.g. be seen in US 2007/0155434 and US 2007/015979. Very often the solution is based on a low cost target, which implies that a high quality goal most often suffers due to a low price of the end user product.

To increase the quality seen from a user perspective, steps must be taken to implement user interfaces that have a higher degree of interactivity with the apparatus/application under control.

In a first aspect, the invention relates to an apparatus for having a user select one or more pieces of information of a plurality of pieces of information, the apparatus comprising:
means for providing, determining, receiving and/or storing the plurality of pieces of information as well as an ordering thereof,
a display for displaying or highlighting to the user one or more pieces of information,
means for detecting or determining a movement along a predetermined closed curve of a movement detecting means or at a movement detecting means and for correlating the detected/determined movement to a direction in the order,
means for controlling the display to display or highlight a first group of the plurality of pieces of information, and for, upon the detection/determination of a movement, controlling the display to display or highlight to the user a second group of the plurality of pieces of information, the pieces of information of the second group being positioned further in the direction of the order than the pieces of information of the first group, and
means for the user to select a displayed or highlighted piece of information, the apparatus further comprising first means for determining or detecting a touch or other engagement of the movement detecting means at one or more first predetermined positions along the closed curve and for then selecting, highlighting and/or displaying one or more predetermined pieces of information of the plurality of pieces of information.

In the present context, a user may select one or more pieces of information of a plurality of pieces of information, for any of a number of reasons.

In a simple embodiment, a piece of information may be a phone number in a list of phone numbers or a name in a list of names (such as in a phone book or a list of artists on an MP3 player). The selection then may be that a number or a name to call or e.g. of an artist, the music of which one wishes to listen to.

Pieces of information may be numbers, and the selection process may be that of generating a multi-digit number by sequentially selecting a number of digits or numbers, as is the case when manually entering a phone number.

Pieces of information may also be characters and/or symbols, where the selection process then may be the generation of a text.

Thus, the pieces of information may be any type of information from simple numbers/digits/signs/symbols/characters to more complex collections thereof.

In common for all types of pieces of information is that an ordering thereof exists or may be generated in that this greatly facilitates searching among the pieces of information. This ordering may be fixed as that of an alphabet, but may also vary as e.g. the symbol keys on a keyboard may vary from keyboard to keyboard. In fact, it may be desired for the user to be able to him/herself to define this ordering.

According to the invention, the selection is performed on the basis of pieces of information displayed or highlighted on a display. This display may have any shape, size and capability. It may be monochromatic or in colour, it may be an oldfashioned CRT or may e.g. be a LCD/LED panel. It may be backlit or not and preferably is a display normally used for portable equipment, such as laptop computers, cell phones, PDA's and/or MP3 players.

In addition to displaying one or more items of information on the display, one or more of the displayed items may be highlighted. This is, e.g., advantageous if multiple items are displayed and only one or a fewer number is to be selected. In this manner, it is not required to reduce the number of displayed items; the one or fewer items may then be highlighted in order to inform the system that these items are to be treated “differently”, such as that they are selected or selectable.

This highlighting may be any manner of illustrating that this/these items is/are different: enlargement/decrease in size compared to other items displayed, or the providing of different colours of the items or surrounding area of the display, animation, or the like.

In order to navigate in the items of information, such as to have other pieces of information represented on the display or other displayed pieces of information highlighted, a rotational movement is detected or determined. The movement may be along a predetermined closed curve, such as by touching a touch sensitive surface along a closed curve without moving any other elements, moving a system having a movement sensor (gps, gyro, camera) along a closed curve, or detecting or determining a movement of a movable or rotatable element of the system, parts of which element will then move along a closed curve, such as a circle, an oval, a square, or the like.

The use of the closed curve enables a user to provide the movement endlessly. Thus, a scrolling, which this may be seen as, may be performed endlessly instead of what could be seen as pressing a “page down” or a “page up” button, which performs only a limited scrolling.

It should be noted that the movement determination may be a determination of the direction of movement (such as seen from a centre axis extending through the closed curve) and/or a determination of a movement velocity, which may be used for determining scroll-direction and scroll velocity, if desired.

When the pieces of information are ordered (linearly), it is simple to correlate the detected/determined movement to a direction in the order. Thus, movement in one direction will scroll toward one direction, and movement in the other direction may scroll toward the other direction.

The result of this movement is displayed on the display by, before performing the movement, displaying or highlighting a first group of the plurality of pieces of information, and for, upon the detection/determination of a movement, controlling the display to display or highlight to the user a second group of the plurality of pieces of information, the pieces of information of the second group being positioned further in the direction of the order than the pieces of information of the first group. Thus, a scrolling is performed in the determined direction. Either actual pieces of information are replaced on the display, and/or other pieces of information are highlighted such as if it is not required to replace displayed pieces of information (i.e. if the pieces of the first and second groups were displayed in the first place).

Subsequent to the scrolling, the user is able to select a displayed and/or highlighted piece of information. Then, as will be described further below, this selected item may be used in a multitude of manners.

According to the invention, the apparatus further comprises first means for determining or detecting a touch or other engagement of the movement detecting means at one or more first predetermined positions along the closed curve. Thus, touching predetermined positions may bring about a selection of predetermined piece(s) of information independently of the position of the scrolling and which piece(s) of information is/are displayed. Thus, a mode dependent operation is seen where particular numbers are provided when e.g. operating as a telephone or a calculator, and particular names may be provided when operating as a player.

Naturally, this touch/engagement/activation may be a stationary touch or a touch which moves with a velocity below a predetermined velocity, in order to be able to distinguish between touches generating the moving touch causing scrolling and touches of predetermined positions. Thus, touches or movements below a predetermined velocity may be “stationary” touches/engagements bringing about (if performed at the predetermined position) the selection or displaying of predetermined piece(s) of information and touches/engagements or movements above the predetermined velocity may be taken as a scrolling.

Alternatively, different types of sensors may be used for determining the movement and the touch or other engagement. Thus, if a rotatable element is used, a rotation sensor may be used for determining the movement, and individually positioned touch/force sensors may be used for determining touches on the rotatable element at the predetermined position(s).

Consequently, a standard scrolling using a movement along a closed curve (such as is seen on Ipods® or cell phones from Samsung® and Bang & Olufsen®) may be used, which has been improved by adding the predetermined positions where e.g. often used pieces of information may be selected directly without having to scroll to the particular position in the order of the pieces of information.

Naturally, any underlying process may be used subsequent to the selection process, such as the calling of a person, who's name or number (for example) was selected in the selection process, or a track, the artist of which has been selected.

In a preferred embodiment, the apparatus further comprises second means for determining or detecting a (such as a stationary) touch or other engagement of the movement detecting means at one or more second predetermined positions, which second position(s) is/are different from the first position(s), along the closed curve, and for selecting and/or displaying one or more predetermined combinations of pieces of information of the plurality of pieces of information.

In the present context, a combination of pieces of information may be any combination, such as when combining individual digits to form a multi-digit number (such as 1084330) or the generation of a text or word from a number of characters/letters/symbols.

Thus, preferably, the apparatus also comprises combining means for having the display display a combination of one or more selected pieces of information.

The actual manner of combining the pieces of information will depend on the actual pieces of information. The combination of letters into a word will be the adding, to e.g. the right side of the previously selected letters of a new letter. Thus, the reading direction of the combined pieces of information is used. The same is the situation when combining items into more complex texts or numbers or the like. Naturally, intelligent dictionaries may be used for suggesting words/numbers/names either from a database of possible or typical words or from a list of words/artists/numbers to which additional information is available. Thus, when entering a telephone number, the display may display telephone numbers which have the hitherto selected numbers (from the left side of the number—or maybe even at any position in the telephone number) therein. When more numbers, then, are added to the selected (maybe combined) items, a list of potential numbers, between which the user may choose, will be narrowed or shortened.

Naturally, the apparatus could further comprise means for the user to input information identifying the predetermined pieces of information of the plurality of pieces of information to be selected when a predetermined position is touched/engaged. Thus, the user may him/herself identify which pieces of information are to be selected when touching or otherwise activating the predetermined positions.

The actual manner of selecting a piece of information may be any suitable manner, such as the touching/engaging a button, another predetermined position along the closed curve, the providing of audio instructions or video instructions, predetermined movement or other engagement of the system or the like.

In general, of course, the apparatus may be adapted to actually perform the same method on the basis of many different types of pieces of information (telephone numbers, names, words, tracks, or the like), where different items may be assigned to different predetermined positions, depending on in which pieces of information the actual search is performed. Again, a mode specific operation may be obtained.

In one particular embodiment, the pieces of information are letters and/or symbols, wherein the combining means are adapted to control the display to display a text generated from the selected letters/symbols. In this situation, the activation of a predetermined area may display or select a predetermined text.

Having then generated a text, any suitable next step may be performed on the basis of this text. The text may be seen as a text message to be transmitted to a receiver, or it may be taken as an instruction to be carried out by the apparatus (call a person, play a track, delete information, close down an application or the like).

In addition, the final selection of a piece of information (combined or not) may cause a new search or scrolling to be initiated. An example is the selection of the name of an artist, where after the available tracks of that artist will be displayed to be selected between. Then, a new search may be made between such track names.

In another embodiment, the pieces of information are numbers and/or symbols, and the combining means are adapted to control the display to display a multi-digit number. Then, the second means could be adapted to display a predetermined multi-digit number.

The combining means could be used for providing multi-digit numbers for calling a person or for use in e.g. a pocket calculator.

Then, as described above, a complete telephone number or simply an area code could be selected/displayed upon activation of a predetermined area or position.

In one embodiment, the means for detecting or determining a movement comprises a rotatable part and means for detection/determination of a direction of rotation and/or an angle of rotation of the rotatable part. In one situation, this could be a revolution/rotation counter/sensor or an angle sensor, and particular pressure sensors could be provided for identifying activation of a position.

In another embodiment, the means for detecting or determining a movement comprises a touch pad and means for detection/determination of a direction of movement of a touch of the surface around an axis/position thereof and/or an angle of rotation around the axis/position. In that situation, the same means may be used for determining the movement and the activation of the position(s). Differing between a position on the curve and a movement along the curve may be made on the basis of a period of time during which the position (or a suitable area around it) is activated—or by analyzing any velocity of the touch along the touch sensitive surface at the predetermined position.

In one embodiment, the pieces of information relate to events, the means for the user to select an event comprises means for providing the event to the user, and first means are adapted to select a predetermined event from the list of:
the most recently provided event,
the most often provided event,
the event provided the most often within a predetermined time period, and
the most often provided event with/by a given artist.

In this context, an event may be any type of event, such as an audio track, a video sequence, or the like.

In another embodiment, the pieces of information are images, the means for the user to select an image are adapted to control the display to display the image to the user, and the first means are adapted to select a predetermined image from the list of:
the most recently displayed image,
the most often displayed image,
the image displayed the most often within a predetermined time period, and
the most often displayed image with/by a particular person.

A second aspect of the invention relates to a method of allowing a user to select one or more pieces of information from a plurality of pieces of information, the method comprising:
providing, determining, receiving and/or storing the plurality of pieces of information as well as an ordering thereof,
displaying or highlighting to the user a first group of the plurality of pieces of information, in the order,
detecting or determining a movement along a predetermined closed curve of a movement detecting means or at a predetermined closed curve of a movement detecting means,
correlating the detected/determined movement to a direction in the order and displaying or highlighting to the user a second group of the plurality of pieces of information, the pieces of information of the second group being positioned further in the direction of the order than the pieces of information of the first group,
the user selecting a displayed or highlighted piece of information,
   the method further comprising determining or detecting a touch or other engagement of the movement detecting means at one or more first predetermined positions along/on the closed curve and selecting, highlighting and/or displaying one or more predetermined pieces of information of the plurality of pieces of information.

As mentioned above, this may be a standard scrolling as is performed on an Ipod® or a cell phone from Samsung® or Bang & Olufsen® combined with use of the predetermined position(s) for providing predetermined piece(s) of information without having to scroll for it.

In one embodiment, the method further comprises the steps of:
determining or detecting a (such as a stationary) touch or other engagement of the movement detecting means at one or more second predetermined positions, which second position(s) is/are different from the first position(s), along the closed curve and
selecting and/or displaying one or more predetermined combinations of pieces of information of the plurality of pieces of information.

Naturally, the method may further comprise the step of combining one or more selected pieces of information into e.g. words, text, numbers or the like.

It may be desired that the method further comprises the step of a user inputting information as to which pieces of information of the plurality of pieces of information is/are the predetermined pieces of information.

In one situation, the pieces of information are letters and/or symbols, and the combination of the letters/symbols is a generation of a text from the selected letters/symbols. In this situation, a predetermined letter/symbol could be a space. Also, a predetermined combination of letters/symbols could be a predetermined text, such as a name and/or a title.

In another situation, the pieces of information are numbers and/or symbols, and the combining of the numbers/symbols is a generation of a multi-digit number. In that situation, a predetermined combination of numbers/symbols could be a predetermined multi-digit number, such as a complete telephone number or an area code.

In one embodiment, the step of detecting or determining the movement comprises:
the user rotating a rotatable part and
a detection/determination of a direction of rotation and/or an angle of rotation of the rotatable part.

Then, the detection of the activation of a predetermined position may be performed using particular sensors to that effect.

In another embodiment, the step of detecting or determining the movement comprises:
the user touching a touch pad along an at least substantially closed path thereof and around a central axis or position and
a detection/determination of a direction of movement of the touch around the axis/position and/or an angle of rotation around the axis/position.

In that situation, the same means may be used for sensing/determining movement and the touch/activation.

In one situation, the pieces of information relate to events, the step of selecting an event comprises providing the event to the user, and the step of selecting a predetermined event comprises providing an event from the list of:
the most recently provided event,
the most often provided event,
the event provided the most often within a predetermined time period, and
the most often provided event with/by a given artist.

In another situation, the pieces of information are images, the step of selecting an image comprises displaying the image to the user, and the step of selecting a predetermined image comprises displaying an image from the list of:
the most recently displayed image,
the most often displayed image,
the image displayed the most often within a predetermined time period, and
the most often displayed image with/by a particular person.

In the following, a preferred embodiment of the invention will be described with reference to the drawing, wherein:

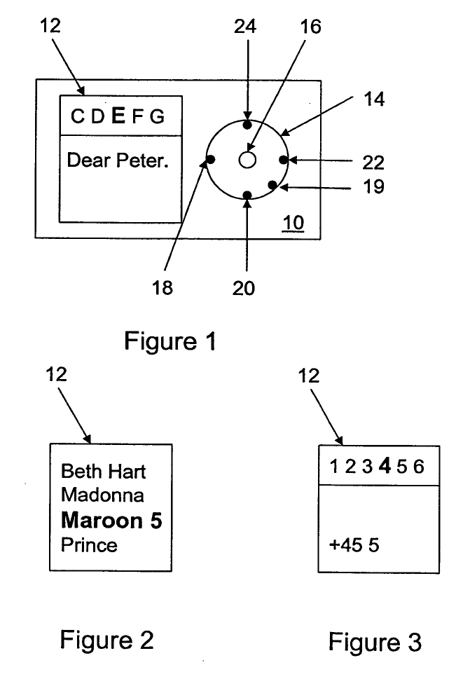

FIG. 1 illustrates a user interface for the user to select pieces of information.

FIG. 2 illustrates scrolling in another type of information,

FIG. 3 illustrates combination of pieces of information,

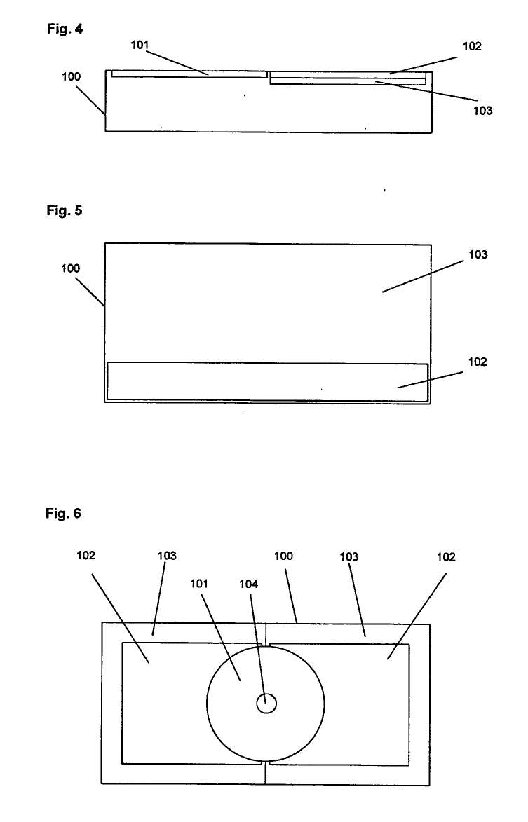

FIG. 4 illustrates another embodiment of the apparatus according to the invention,

FIGS. 5-6 illustrate other embodiments of the apparatus according to the invention,

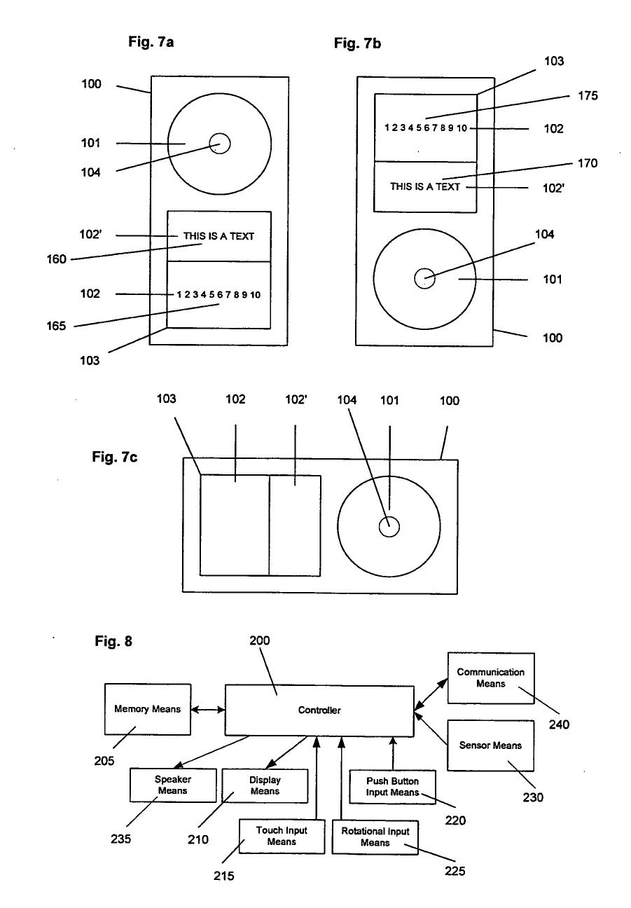

FIG. 7 illustrates three embodiments of the apparatus according to the invention,

FIG. 8 illustrates a block diagram of the contents of the preferred apparatus and

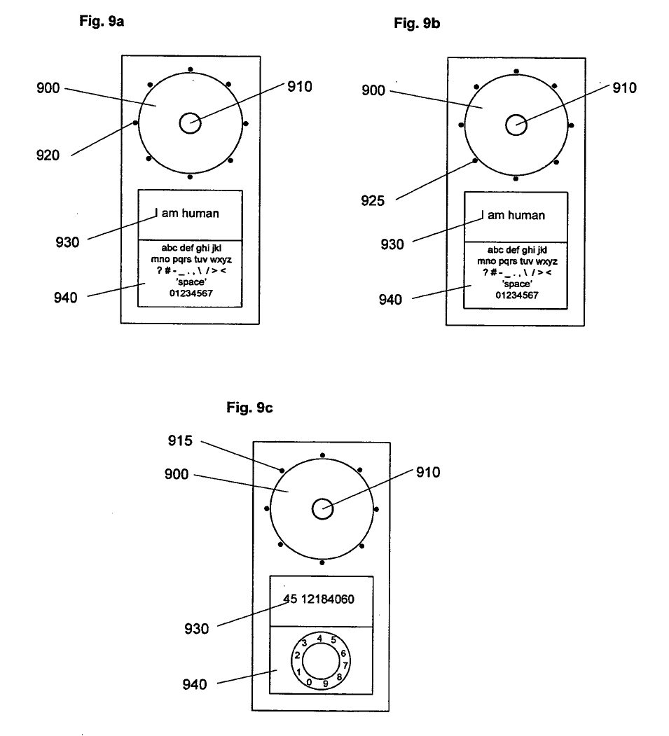

FIG. 9 illustrates further embodiments.

In FIG. 1, a user interface is illustrated of an apparatus 10 having a display 12 for providing information to the user as well as an input element 14 comprising a circular element for the user to manipulate.

The circular element 14 may be a rotatable wheel for the user to rotate or a touch pad for the user to touch in a rotational manner.

Thus, when the element 14 is a rotatable wheel or element, a rotation sensor of any type may be provided for sensing the rotation, such as a velocity of rotation and/or a direction thereof. Then, sensors may be provided for sensing activation/engagement/touch/pressure of the element 14 at the predetermined positions.

When the element 14 is a touch pad, the same touch pad may be used for sensing movement along a closed path (which then need not be circular) as well as touch/activation/engagement of predetermined positions.

One manner of using the input element would be when scrolling through pieces of information illustrated on the display 12 using a rotational movement or touch of the element 14. The display then will illustrate the scrolling of the pieces of information on the display. This type of scrolling is a standard procedure seen on e.g. the Ipod®.

Also, the input element 14 comprises a button or element 16 for the user to use for selecting a piece of information displayed on the display 12, such as in a predetermined position or otherwise highlighted, if more than one piece of information is displayed at the same time.

In the present example, the user interface is used for generating a text message, such as an SMS or the like.

As is illustrated, the display is divided into an upper spelling part and a lower text message part. Thus, by rotating the element 14—or by performing a rotational touching movement thereof, the letters displayed in the upper display part will be translated left/right, and the centre letter/sign will be highlighted for selection. Thus, as is usual in this type of display, an order is determined between the letters and signs in order to ease navigation/scrolling to find the next letter/sign.

Selection may be performed by pressing the centre button 16. Thus, the message, as is usual, is generated one letter at the time.

Naturally, an intelligent dictionary may be used in order to predict the words generated so as to generate messages faster.

However, the present element 14 has, in this example, four pre-determined positions 18, 20, 22, and 24, as illustrated by black dots, which may be pressed or activated instead of the rotational movement.

Activating or pressing a position 18/20/22/24 will bring about the selection of a predetermined one of the letters/signs. Thus, a number of the letters/signs may be assigned a “hot key” or “selected position”, so that it may swiftly be selected. This normally will be often used letters, such as the letter “e”, but also the “space” which is one of the more often used characters.

Naturally, a position may also be used for providing a whole word (such as “Peter” or “darling”) or a number of predetermined letters/signs (such as “Yours truly, Peter”).

Touching or pushing at the positions 18/20/22/24 may be detected using one of four force detectors positioned at such positions. Then, a position, 19, positioned directly between positions 20 and 22 may be detected by detecting an activation of both the detectors at 20 and 22.

In another example, seen in FIG. 2 illustrating only the display 12, the pieces of information provided on the display are artist names, between which the user may scroll and select one, music of which the user wishes to listen to, for example. The pieces of information could just as well be track names or the like.

Again, the scrolling and selection may be a standard scrolling performed by the rotating movement and the selection using the button 16, but the positions 18/20/22/24 may be used for selecting predetermined artists, such as favourite artists of the user,

Alternatively, the positions 18/20/22/24 may be pre-programmed to provide the last played track, the most often played track, and/or the most often played track from a given favourite artist, or the like.

In a further example, as is illustrated in FIG. 3, the user may select between the numbers 0-9 and a few symbols in order to enter a telephone number. Again, the individual numbers/symbols may be selected using a scrolling, where part of the display is used for illustrating the numbers during scrolling, and one may be selected using the button 16.

Alternatively, the scrolling may be in a complete list of telephone numbers of e.g. a telephone book of the apparatus 10.

Then, different positions 18/20/22/24 may be used for often used numbers (such as area codes) or may be used for particular, complete telephone numbers, such as that of ones children or parents.

Thus, the invention enables a new user friendly man-machine-operational mode of operation in handheld consumer electronics.

In one aspect the invention relates to a device (100) including three structural elements:
a first member (101) configured as input detection means, which detection device can sense and quantify rotational movements given by the finger of the user; and
a second member (102) configured as transparent touch sensing means, which touch detection device can sense and quantify commands given by the finger of the user; and
a third member (103) configured as display means to provide information to the user; this information being partly or fully a result of the user activated rotational movements via the first member (101), or the information being partly or fully a result of the user activated command via the second member (102), or the information being partly a result of an application program controlled by the user via the first member (101) and/or controlled by the user via the second member (102); and
the second member (1 02) physically being located partly or fully over the third member (103) enabling the assembly of the second member (102) and the third member (103) to provide touch sensitive display means.

As displayed in FIG. 7a in a preferred embodiment the device (100) is configured with the first member (101) implemented as wheel shaped detector, and the wheel positioned in the upper half of the device (100); the display and touch sensitive screen (102, 102′, 103) is positioned in the lower half of the device (100).

As displayed in FIG. 7b in a preferred embodiment the device (100) is configured with the first member (101) implemented as wheel shaped detector, and the wheel positioned in the lower half of the device (100); the display and touch sensitive screen (102, 102′, 103) is positioned in the upper half of the device (100).

As displayed in FIG. 7c in a preferred embodiment of the device (100) is depicted when the device (100) is rotated from a vertical upright position (4a or 4b) to be in a horizontal right/left oriented position.

In a preferred embodiment the device (100) is configured with the first member (101) being a rotational mechanical wheel. Known technologies are applied as rotational input means (225), to detect the rotation of the wheel performed by the user operation. These means include e.g. an opto-coupler to detect the rotation of the wheel and simple switches to detect selections performed by the user, selections in terms of depression on the perimeter of the wheel or on the centre of the wheel.

A dedicated push button (104) may be part of the wheel construction (101).

Alternative means for the rotational detection method may be touch technologies known in art, like a touch based implementation with capacitive touch sensors or strain gauge sensors.

A dedicated touch pad (104) may be part of the touch wheel/pad construction (101).

In a preferred embodiment supplemental input means in terms of push buttons (104) may be implemented. One or more buttons may apply according to actual functional requirements of the apparatus. Known technologies like simple switches may be applied as push button input means (220).

In a preferred embodiment the first member device (101) and the second member device (102) are located on the front surface of the apparatus (100), in a manner where it appears to be an embedded part of the apparatus, i.e. having a plane surface in the final assembly.

Other embodiments may include variants having the first member (101) in one physical part of the apparatus and the second and third members (102,103) in another physical part of the apparatus. As an example is a foldable cell-/mobile phone having two parts connected by a hinge, where one part holds the input means (101) and another part holds the touch display means (102,103).

In a preferred embodiment the outer form of the second member (102) touch input pad is identical to the outer form of the third member (103) display. According to actual product requirements of an apparatus this may vary, such that the shape of the second member (102) may take any geometrical form, and cover the third member (103) display fully or partly accordingly.

In a preferred embodiment the outer geometrical form of the third member (103) display is a square or a rectangle. According to actual product requirements of an apparatus this may vary, such that the shape of the third member (103) may take any geometrical form.

In a preferred embodiment the second member (102) detection device is one physical unit/object having one logical object related, which object may be subdivided into two or more logical entities, where each entity may be controlled individually by the computer control means of the apparatus. This enables that the touch input may the part of a dynamic interactive content sensitive mode of operation controlled by the control means of the apparatus (200).

In a preferred embodiment the third member (103) display device is one physical unit/object having one logical object related, which object may be subdivided into two or more logical entities, where each entity may be controlled individually by the computer control means of the apparatus. This enables that the display may the part of a dynamic interactive content sensitive mode of operation controlled by the control means of the apparatus (200). In a preferred embodiment the subdivision of each of the physical objects, i.e. the display and the touch input means, from one logical entity into two or more logical entities, may be performed automatically according to the actual mode of operation, i.e. the transition is caused by the user given control commands, and the content and context of the actual application program of the apparatus.

The reconfiguration from two or more logical entities back to one logical entity may be performed automatically by the control means (200) according to the actual mode of operation of the apparatus.

Another aspect of the invention is the synchronous mode of operation, where a high degree of interactivity in the man-machine-interface is obtained.

In a preferred embodiment different input means are available for the user: push button input (104), wheel/rotational input (101), interactive touch sensitive input (102). In addition to the pre-programmed command keys that may be selected from the touch input (102), the user may define soft-keys, that relates to function selection, soft-keys that will appear as selectable options on the touch screen display (103).

Information is communicated to user via the display output (103) and/or as sound signals via a speaker (235), this audio signal may be communicated e.g. as an acknowledgement to a user operation of the wheel input (101).

During operation the user may pass control input via the button input (104), via the wheel/rotational input (101), and via the interactive touch sensitive input (102) as appropriate according to the user wishes/demands and according to the optional features offered by the apparatus as determined by context and content of an actual situation.

An example of sequence of operation and user selections may be:
1. initiate operation by pressing the push button (104), the touch sensitive display is updated accordingly;
2. continue with input selection from the wheel (101), the touch sensitive display is updated accordingly;
3. continue with input selection from the wheel (101), the touch sensitive display is updated accordingly;
4. continue with input selection from the touch (102), the touch sensitive display is updated accordingly;
5. continue with input selection from the touch (102), the touch sensitive display is updated accordingly;
6. terminate operation by pressing the push button (104), the touch sensitive display is updated accordingly;

Another example of sequence of operation and user selections may be:
1. initiate operation by pressing the wheel (101), the touch sensitive display is updated accordingly;
2. continue with input selection from the touch (102), the touch sensitive display is updated accordingly;
3. continue with input selection from the touch (102), the touch sensitive display is updated accordingly;
4. continue with input selection from the wheel (101), the touch sensitive display is updated accordingly;
5. terminate with input selection from the wheel (101), the touch sensitive display is updated accordingly;

Yet another example of sequence of operation and user selections may be:
1. Initiate operation with input selection from the touch (102), the touch sensitive display is updated accordingly;
2. continue with input selection from the touch (102), the touch sensitive display is updated accordingly;
3. continue with input selection from the wheel (101), the touch sensitive display is updated accordingly;
4. continue with input selection from the push button (104), the touch sensitive display is updated accordingly;
5. terminate with input selection from the wheel (101), the touch sensitive display is updated accordingly;

In yet another aspect, the invention relates to a method of providing information to a user, the method comprising:
1. displaying the information to the user,
2. detect rotating of the apparatus,
3. quantifying an angle of rotation of the apparatus,
4. rotating the information displayed on the display, and in relation to the display by an angle relating to the angle of rotation.

The technology of the sensor (225) is known in the prior art. These are sensors like a Gyro, or simpler sensor switches to detect if an object is positioned in the positions: vertical upward, vertical downward, horizontal right, or horizontal left.

The rotation on the display (103) is determined by the detected rotation of the unit (100). With the apparatus being in an upward position the information is ordered accordingly (160, 165). With the unit (100) turned 180°, the apparatus being in a downward position the information is ordered accordingly (170, 175).

FIG. 4, displays a side view of an example of a configuration of the apparatus (100), including the surface mounted input mean (101) that detects user given rotational control commands and the interactive touch input mean (102), which is located on top of the display mean (103).

FIG. 5, displays a top view of an example of a configuration of a interactive touch screen, consisting of the components: the display mean (103), e.g. an LCD or OLED screen, which screen may cover fully the surface of the device (100), and the input touch mean (102), which touch mean being transparent and may partly cover the display (103).

FIG. 6, displays a top view of an example of a configuration of an apparatus having an interactive touch screen that is symmetrically subdivided into two logical entities, consisting of the components: the display mean (103), which screen may cover fully the surface of the device (100), and the input touch mean (102), which touch mean may partly cover the display (103).

The apparatus has a round/wheel detector (101) imbedded, and a push button (104), which push button may be an individual object (mechanical or touch based) or it may be an integrated part of the round sensing element (101).

FIG. 7, displays three embodiments (100), which are very similar to each other.

A top view of an example of a configuration of an apparatus having an interactive touch screen that is subdivided into two logical entities, consisting of the components: the display mean (103), and the first logical entity of the input touch mean (102), and the second logical entity of the input touch mean (102′) which touch mean may fully cover the display (103).

The apparatus has a round/wheel detector (101) imbedded, and a push button (104), which push button may be an individual object (mechanical or touch based) or it may be an integrated part of the round sensing element (101).

FIG. 7, displays in addition how different fixed configurations of the apparatus may be implemented according to different product requirements.

FIG. 7a, displays an example of a configuration having the round sensing element in the upper half of the surface of the apparatus and the touch sensitive display in the lower half of the device.

FIG. 7b, displays an example of a configuration having the round sensing element in the lower half of the surface of the apparatus and the touch sensitive display in the upper half of the device.

FIG. 7c, displays an example of a configuration having the round sensing element in the right half of the surface of the apparatus and the touch sensitive display in the left half of the device.

FIG. 7, displays in addition how different configurations of the apparatus may appear having a flexible configuration according to different product requirements.

FIG. 7a, displays an example when the apparatus is held in hand in an upward position. The touch sensitive display is automatically configured with the display information and the touch input menus in an upright position (160,165).

FIG. 7b, displays an example when the apparatus is held in hand in a downward position. The touch sensitive display is automatically configured with the display information and the touch input menus in an upside-down position (170,175).

FIG. 8 illustrates the components of the embodiment of FIG. 7.

It is seen that a controller (200) controls memory means (205) accessing both the application program relevant for the apparatus as well as the dynamic data needed for processing. In addition, the controller (200) controls the display means (210) in order to display both the dialog information relevant for the user in the interactive control of the apparatus, as well as information sourced by the application program execution. The controller (200) also controls or interacts with input means, this being the push button means (220), the rotational input means (225) and the touch input means (215). The controller (200) may generate an appropriate audible signal via the speaker (235). The controller (200) receives and processes information from sensor means (230) adapted to sense and quantify the orientation and rotation of the apparatus (100).

Finally the controller manages wireless communication means (240) like Bluetooth and mobile-/cell phone signals according to an actual implementation of an apparatus.

In FIG. 9, additional embodiments are seen where a wheel or touch pad 900 has a total of eight pre-determined positions 920 as well as two displays 930 and 940. Then, the upper display 930 may be used for generating a combination of information items, such as the generating of a text, and the lower display, 940, may be used for representing characters or other pieces of information. The pieces of information may be provided in groups, between which a first selection is made to select a group, and within which a second selection is made to select the desired piece of information of the selected group. It is seen that both individual pieces of information as well as different types of “functions” or special characters, such as new line, may be selected.

Alternatively, a scrolling may be performed between all individual pieces of information.

In FIG. 9c it is seen that the lower display may be a touch screen via which the user may enter additional pieces of information instead of scrolling to the piece of information or assigning it to a predetermined position.

In addition to the selection of pieces of information, different functions or operations may be selected by either engaging suitable positions on the touch screen 940 or predetermined positions on the wheel/touch pad 14/101. Such functions may be the playing of a track selected by the scrolling/selecting procedure, calling a number selected by the scrolling/selecting procedure, transmitting/editing a text generated/combined using the scrolling/selecting procedure, or the moving between different modes of operation, such as the shifting between text entering (when scrolling), text editing (moving a cursor due to the movement), telephone operation, track selecting/playing or the like.

As is mentioned further above, a mode dependent operation is desired in that the types of information items will depend on the mode (telephone, player, calculator, navigator or the like), and the use of a touch screen will support such different modes without requiring special purpose information entering means for each mode.

1-23. (canceled)

24. An apparatus for having a user select one or more pieces of information of a plurality of pieces of information, the apparatus comprising:
means for providing, determining, receiving and/or storing the plurality of pieces of information as well as an ordering thereof,
a display for displaying or highlighting to the user one or more pieces of information,
means for detecting or determining a movement along a predetermined closed curve of a movement detecting means or at a movement detecting means and for correlating the detected/determined movement to a direction in the order,
means for controlling the display to display or highlight a first group of the plurality of pieces of information, and for, upon the detection/determination of a movement, controlling the display to display or highlight to the user a second group of the plurality of pieces of information, the pieces of information of the second group being positioned further in the direction of the order than the pieces of information of the first group, and
means for the user to select a displayed or highlighted piece of information,
first means for determining or detecting a touch or other engagement of the movement detecting means at one or more first predetermined positions along the closed curve and for then selecting, highlighting and/or displaying one or more predetermined pieces of information of the plurality of pieces of information and
second means for determining or detecting a touch or other engagement of the movement detecting means at one or more second predetermined positions, which second position(s) is/are different from the first position(s), along the closed curve, and for selecting and/or displaying one or more predetermined combinations of pieces of information of the plurality of pieces of information.

25. An apparatus according to claim 24, further comprising combining means for having the display display a combination of one or more selected pieces of information.

26. An apparatus according to claim 24, the apparatus further comprising means for the user to input information identifying the predetermined pieces of information of the plurality of pieces of information.

27. An apparatus according to claim 25, wherein the pieces of information are letters and/or symbols, and wherein the combining means are adapted to control the display to display a text generated from the selected letters/symbols.

28. An apparatus according to claim 27, wherein the pieces of information are numbers and/or symbols, and wherein the combining means are adapted to control the display to display a multi-digit number.

29. An apparatus according to claim 24, wherein the means for detecting or determining the movement comprises a rotatable part and means for detection/determination of a direction of rotation and/or an angle of rotation of the rotatable part.

30. An apparatus according to claim 24, wherein the means for detecting or determining the movement comprises a touch pad and means for detection/determination of a direction of movement of a touch around the axis/position and/or an angle of rotation around the axis/position.

31. An apparatus according to claim 24, wherein the pieces of information relate to events, the means for the user to select an event comprises means for providing the event to the user, and first means are adapted to select a predetermined event from the list of:
the most recently provided event,
the most often provided event,
the event provided the most often within a predetermined time period, and
the most often provided event with a given artist.

32. An apparatus according to claim 24, wherein the pieces of information are images, the means for the user to select an image are adapted to control the display to display the image to the user, and the first means are adapted to select a predetermined image from the list of:
the most recently displayed image,
the most often displayed image,
the image displayed the most often within a predetermined time period, and
the most often displayed image with a particular person.

33. A method of allowing a user to select one or more pieces of information from a plurality of pieces of information, the method comprising:
providing, determining, receiving and/or storing the plurality of pieces of information as well as an ordering thereof,
displaying or highlighting to the user a first group of the plurality of pieces of information, in the order,
detecting or determining a movement along a predetermined closed curve of a movement detecting means or at a predetermined closed curve of a movement detecting means,
correlating the detected/determined movement to a direction in the order and displaying or highlighting to the user a second group of the plurality of pieces of information, the pieces of information of the second group being positioned further in the direction of the order than the pieces of information of the first group,
the user selecting a displayed or highlighted piece of information,
determining or detecting a touch or other engagement of the movement detecting means at one or more first predetermined positions along/on the closed curve and selecting, highlighting and/or displaying one or more predetermined pieces of information of the plurality of pieces of information,
determining or detecting a touch or other engagement of the movement detecting means at one or more second predetermined positions, which second position(s) is/are different from the first position(s), along the closed curve and
selecting and/or displaying one or more predetermined combinations of pieces of information of the plurality of pieces of information.

34. A method according to claim 33, the method further comprising the step of combining one or more selected pieces of information.

35. A method according to claim 33, the method further comprising the step of a user inputting information as to which pieces of information of the plurality of pieces of information is/are the predetermined pieces of information.

36. A method according to claim 33, wherein the pieces of information are letters and/or symbols, and wherein the combination of the letters/symbols is a generation of a text from the selected letters/symbols.

37. A method according to claim 33, wherein the pieces of information are numbers and/or symbols, and wherein the combining of the numbers/symbols is a generation of a multi-digit number.

38. A method according to claim 33, wherein the step of detecting or determining the movement comprises:
the user rotating a rotatable part and
a detection/determination of a direction of rotation and/or an angle of rotation of the rotatable part.

39. A method according to claim 33, wherein the step of detecting or determining the movement comprises:
the user touching a touch pad along an at least substantially closed path and around a central axis or position and
a detection/determination of a direction of movement of the touch around the axis/position and/or an angle of rotation around the axis/position.

40. A method according to claim 33, wherein the pieces of information relate to events, the step of selecting an event comprises providing the event to the user, and the step of selecting a predetermined event comprises providing an event from the list of:
the most recently provided event,
the most often provided event,
the event provided the most often within a predetermined time period, and
the most often provided event with a given artist.

41. A method according to claim 33, wherein the pieces of information are images, the step of selecting an image comprises displaying the image to the user, and the step of selecting a predetermined image comprises displaying an image from the list of:
the most recently displayed image,
the most often displayed image,
the image displayed the most often within a predetermined time period, and
the most often displayed image with a particular person.
